(19) United States
(12) Patent Application Publication
(10) Pub. No.: US 2014/0189533 A1
(43) Pub. Date: Jul. 3, 2014

(54) DYNAMIC NOTIFICATION SYSTEM AND METHOD

(71) Applicant: AVAYA INC., Basking Ridge, NJ (US)

(72) Inventors: Michael Krack, St. Pete Beach, FL (US); Jai Pugalia, San Jose, CA (US); Jeffrey Wong, San Jose, CA (US); Wayne Wong, Milpitas, CA (US); Lee Shero, McKinney, TX (US)

(73) Assignee: AVAYA INC., Basking Ridge, NJ (US)

(21) Appl. No.: 13/731,032

(22) Filed: Dec. 30, 2012

(51) Int. Cl. G06F 3/048

(52) U.S. Cl. CPC G06F 3/048
USPC 715/753

(57) ABSTRACT

A dynamic notification system for managing notifications on a user device is provided. The dynamic notification system includes a monitor module for monitoring user's interactions with previous notifications on the user device. The dynamic notification system further includes an order module for dynamically determining an order of display for notifications based on the user's interactions with the previous notifications. The dynamic notification system further includes a display module for displaying the notifications based on the determined order. The dynamic notification system also includes a customization module that allows a user to customize the order of display for notifications based upon a source or application associated with a notification.

### BACKGROUND

1. Field of the Invention

Embodiments of the present invention generally relate to notifications on electronic communication devices and particularly to managing notifications on the electronic communication devices.

2. Description of Related Art

Electronic communication devices, e.g., smart mobile devices such as tablets, smart phones, and the like, have recently been an integral part of our lives. These electronic communication devices (collectively referred to herein for ease of reference generally as Smart phones), typically have many applications installed on them. Further, the user may also download more applications from web. Each application provides a notification to a user in case of any updates or events. For example, smart phone displays provide notifications for new email, new SMS, new MMS, pending appointments, as well application specific events such as someone has posted an item of interest to a social application.

As the number of applications on electronic communication devices, like a smart phone, increases, the number of notifications will also generally increase. The smart phone provides a list of notifications for all events from all applications. It is possible that at some time, there may be so many notifications in the list that the user eventually disables or ignores some important notifications.

Today, the list of notifications in a smart phone is typically ordered by time. However, there are a lot of problems associated with this conventional approach. For example, ordering the notifications by time, lists all of the notifications according to their arrival or event time. It is possible that the list of notifications ordered by time, may provide a less important or less relevant notification ahead of another more important or more relevant notification. Hence, the user will see a less important notification first and more important notification later. If the user has limited time to view and respond to the notifications, the user is wasting his valuable time over viewing less important notifications. Further, even if some important notification requires urgent and immediate attention of the user, the notification will lie in the list sorted by time. Hence, the user may miss viewing a notification, and further may also miss responding to an important notification at the right time.

Further, some smart phones allow the user to designate that all notifications from a particular application can be sorted ahead of another application's set of notifications. This approach first requires manual configuration by the user, and further do not solve problem of showing user-relevant notifications. This is because an important notification may come from any application, and if that application is not set to a “favorite” by the user, he may miss reading the notification or responding to the notification at the right time. For example, if the user has set missed calls notifications ahead of SMS notifications, then it is possible, at some time, that the user may receive some important notification through the SMS, and not by phone call.

Furthermore, some smart phones also allow the user to manually configure a maximum number of notifications from each application or turn them off completely on an application by application basis. The manual configuration options also do not solve the problem of showing user-relevant notifications. First, the manual configuration option requires that the user manually manage the order of the notifications and the maximum number of notifications from each installed application.

Further, if the user adds new applications that generate notifications, the user will have to again manually configure the smart phone for configuring the newly added application for maximum number of notifications. Furthermore, some important notifications may be omitted by setting the maximum number of notifications to a fixed value. For example, a user may have an interest in knowing when they have missed a call from one of their family members. If the maximum number ‘missed calls’ notification is set to 3, the first 3 missed calls may not necessarily have arrived from a family member.

There is thus a need for an improved notification system for managing the notifications in electronic communication devices, e.g., smart phones.

### SUMMARY

Embodiments in accordance with the present invention provide a dynamic notification system for managing notifications on a user device. The dynamic notification system includes a monitor module for monitoring user's interactions with previous notifications on the user device. The dynamic notification system further includes an order module for dynamically determining an order of display for notifications based on the user's interactions with the previous notifications. The dynamic notification system further includes a display module for displaying the notifications based on the determined order.

Embodiments in accordance with the present invention further provide a computer-implemented method for managing notifications on a user device. The computer-implemented method includes monitoring user's interactions with previous notifications on a user device, determining dynamically an order of display for notifications based on the user's interactions with the previous notifications, and displaying the notifications based on the determined order.

Embodiments in accordance with the present invention further provide a computer readable medium storing computer readable instructions when executed by a processor perform a method that monitors user's interactions with previous notifications on a user device, dynamically determines an order of display for notifications based on the user's interactions with the previous notifications, and displays the notifications based on the determined order.

The present invention can provide a number of advantages depending on the particular configuration. First, the present invention requires no manual configuration from the user. The dynamic notification system, provided by the present invention, automatically configures sorting of the notifications based on the user interactions with previous notifications and applications. Further, important notifications are far less likely to be missed by a user, by using the present invention, since there is no finite limit on the number of notifications from a particular application. Further, the user may add as many new applications as he likes without bothering about the notifications. Further, the present invention facilitates dynamic filtering and sorting of notifications and alerts based on user's previous interactions. Furthermore, the present invention is applicable to all electronic communication devices, including but not limited to IP phones, e.g., smart phones, and a broad range of modern smart devices with a GUI.

These and other advantages will be apparent from the disclosure of the invention(s) contained herein.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the present invention is considered to include a tangible storage medium or distribution medium and prior art-recognized equivalents and successor media, in which the software implementations of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

The preceding is a simplified summary of the present invention to provide an understanding of some aspects of the present invention. This summary is neither an extensive nor exhaustive overview of the present invention and its various embodiments. It is intended neither to identify key or critical elements of the present invention nor to delineate the scope of the present invention but to present selected concepts of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a block diagram depicting a network environment according to an embodiment of the present invention;

FIG. 2 is a block diagram of a dynamic notification system according to an embodiment of the present invention; and

FIG. 3 is flowchart depicting an embodiment of the present invention.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Illustrative embodiments of the present invention now will be described more fully hereinafter with reference to the accompanying drawings, in which some, but not all embodiments of the present invention may be shown. Indeed, the present invention may be embodied in many different forms and should not be construed as limited to the embodiments set forth herein; rather, these embodiments may be provided so that this disclosure will satisfy applicable legal requirements. Like numbers refer to like elements throughout.

Further, the present invention will be illustrated below in conjunction with a user device. Although well suited for use with any electronic communication device, e.g., smart phone, laptop, mobile phone, tablet, desktop computer, etc., the present invention is not limited to any particular type of electronic communication device. Those skilled in the art will recognize that the disclosed techniques may be used in any electronic device in which it is desirable to receive notifications.

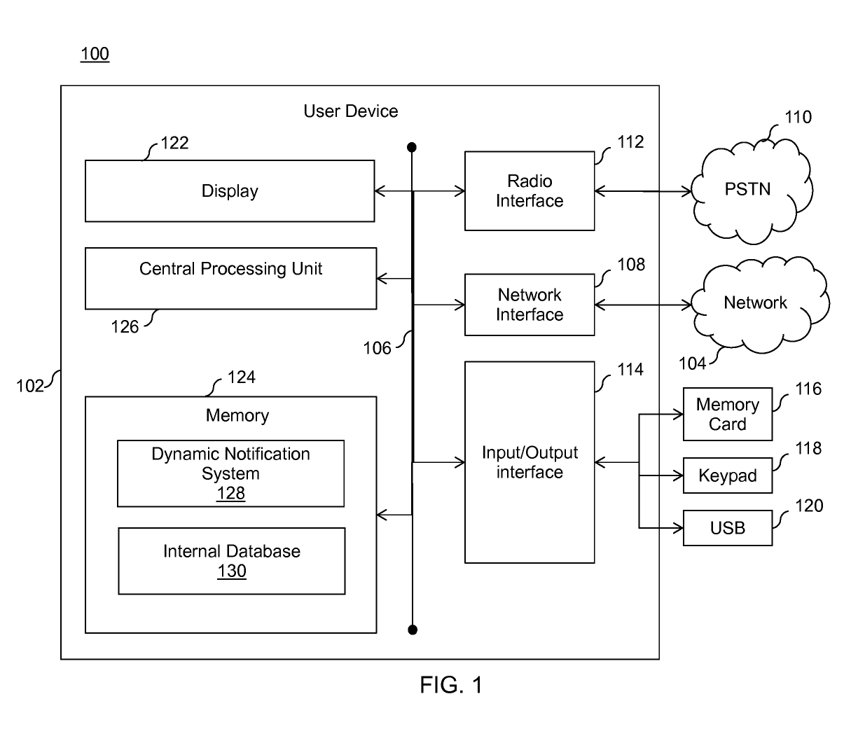

FIG. 1 illustrates an exemplary network environment 100 where various embodiments of the present invention may be implemented. The network environment 100 includes a user device 102 connected to a network 104. The network 104 may include, but is not restricted to, a communication network such as Internet, PSTN, Local Area Network (LAN), Wide Area Network (WAN), Metropolitan Area Network (MAN), and so forth. In an embodiment of the present invention, the network 104 can be a data network such as the Internet. Further, the messages exchanged between the user device 102 and the network 104 can comprise any suitable message format and protocol capable of communicating the information.

FIG. 1 further illustrates exemplary block diagram of the user device 102, in accordance with an embodiment of the present invention. The user device 102 includes a system bus 106 to connect the various components. Examples of system bus 106 include several types of bus structures including a memory bus or memory controller, a peripheral bus, or a local bus using any of a variety of bus architectures. The user device 102 can be a telecommunication device such as, but not limited to, a telephone, a mobile phone, a smart-phone and so forth. The user device 102 may connect to the network 104 through a network interface 108. Further, in an embodiment of the present invention, the user device 102 may also connect to a PSTN 110 through a radio interface 112. In another embodiment of the present invention, the user device may connect to the PSTN 110 through the network 104 and a gateway (not shown in Fig.). Input/output (IO) interface 114 of device 102 may be configured to connect external or peripheral devices such as a memory card 116, a keypad 118 and a Universal Serial Bus (USB) device 120. Although not shown, various other devices may be connected through IO interface 114 to the user device 102. In an embodiment of the present invention, the user device 102 may be connected to a hub device, which may provide various services such as voice communication, Internet access, television services and so forth. For example, the hub may be a Home Gateway device that acts as a hub between the home environment and the Broadband Network.

The user device 102 includes a display 122 to output graphical information to a user of the user device 102. In an embodiment of the present invention, display 122 includes a touch sensitive screen. Therefore, the user can provide inputs to user device 102 by touching the display 122. Memory 124 of user device 102 stores various programs, data and/or instructions that can be executed by Central Processing Unit (CPU) 126. Examples of memory include, but are not limited to, a Random Access Memory (RAM), a Read Only Memory (ROM), a hard disk, and so forth.

A person skilled in the art will appreciate that other types of computer-readable media, which can store data that is accessible by a computer, such as magnetic cassettes, flash memory cards, digital video disks, and the like, may also be used by user device 102. Memory 124 may include Operating System (OS) (not shown) for the user device 102 to function. Further, memory 124 may include other applications (not shown in the figure) that enable the user to open web pages offered by the website. Other applications may be stored as software or firmware on the user device 102.

Further, memory 124 includes a dynamic notification system 128, according to an embodiment of the present invention. The dynamic notification system 128 may be an application stored as a software or firmware on the user device 102. The notifications may be stored in an internal database 130 in the memory 124 of the user device 102. In another embodiment of the present invention, the notifications may be stored external to the user device 102.

The internal database 130 may store a plurality of attributes associated with the notifications. In an embodiment of the present invention, the internal database 130 may store a time stamp associated with each notification system that indicates an event time or arrival time of the notification. Further, the internal database 130 may store the notification itself, for example content of the notification. Further, the internal database 130 may store a type of the notification, for example, whether it is a call, alarm, SMS, email, etc. Further, the internal database 130 may store details of the sender or caller of the notification, i.e., source from where the notification came. Further, the internal database 130 may store name/identity of application that generated the notification. Furthermore, the internal database 130 may store a priority (a default value, for example, 500) for each notification. The priority associated with each notification may be updated based upon user interaction, or user setting, as described below.

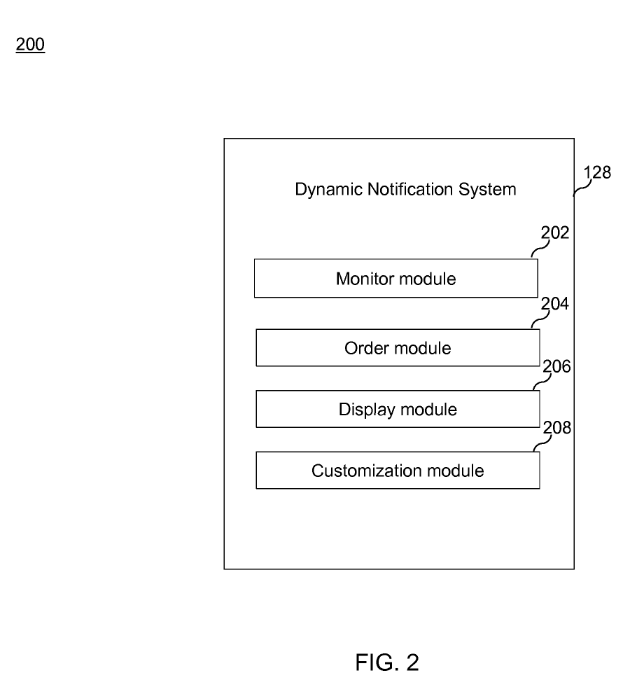

Referring to FIG. 2, the dynamic notification system 128 includes a monitor module 202, an order module 204, a display module 206, and a customization module 208.

In one embodiment of the present invention, the monitor module 202 is configured to monitor user's interactions with previous notifications on the user device. In an embodiment of the present invention, the user may interact or respond to notifications based upon a source (i.e. sender/caller) associated with the notification. For example, the user may always respond to notifications coming from a particular source, e.g., his wife, family member, boss, colleague, etc. However, the same user may always ignore notifications coming from another source, for example, a neighbour, an ex-girlfriend, etc. In one embodiment of the present invention, the monitor module 202 may monitor and store such interactions in the internal database 130.

Further, in another embodiment of the present invention, the user may interact or respond to notifications based upon an application associated with the notifications. For example, the user may keep ignoring phone missed call notifications but always responds back to SMS notifications. In one embodiment of the present invention, the monitor module 202 may monitor and store such interactions in the internal database 130. In another embodiment of the present invention, the monitor module 202 may monitor and store such interactions in an external database (not shown in figure).

Further, in yet another embodiment of the present invention, the user may interact or respond to notifications based upon content (for example, text, images, voice, multimedia, etc.) of the notifications. For example, the user may always read completely an email or message related to new business opportunities. However, the user may not read a spam email or message. The monitor module 202 may remember text from previous notifications acted upon by the user. Further, in an embodiment of the present invention, the user may always like viewing certain type of images or multimedia content, while always dislike and ignore certain images or multimedia content. The monitor module 202 may monitor and store such interactions in the internal database 130.

Further, in an embodiment of the present invention, the monitor module 202 also monitors and observes user's action during user's interaction with applications. For example, the user may reject the call (actively rejecting) or may miss the call. Further, the monitor module 202 also monitors the user's action and overall frequency of usage of different applications.

Further, the monitor module 202 may monitor voice of the caller and record a copy of the voice of the caller. The dynamic notification system may employ various voice recognition techniques and associate the voice with the notification and may utilize the voice in sorting the notifications in future. The monitor module 202 monitors all such interactions of the user with the notifications and stores the interactions in the internal database 130.

The order module 204 dynamically determines an order of display for notifications based on the user's interactions with the previous notifications. The order of display for the notification may include more important notifications for the user at top of notification list, and less important notification for the user at bottom of the notification list. For example, if the user always responds to notifications coming from a particular source, e.g., his wife, family member, boss, colleague, etc., the order module 204 may automatically display notifications coming from those sources at top of the list of notifications. The order module 204 may assign a high priority to the notifications coming from those sources. Further, if the user always ignores notifications coming from another source, for example, a neighbour, an ex-girlfriend, etc., the order module 204 may display notifications from those sources at bottom of the list of notifications. The order module 204 may assign a low priority to the notifications coming from those sources.

The order module 204 is further configured to prioritize notifications associated with an application based upon the user's interaction with the previous notifications associated with that application. For example, if the user keeps ignoring phone missed call notifications but always responds back to SMS notifications, then the order module 204 may display SMS notifications at top of the list of notifications and the missed call notifications at bottom of the list of notifications.

Further, in one embodiment of the present invention, the order module 204 is configured to utilize the content (for example, text, image, multimedia, etc.) from the previous notifications acted upon by the user in determining order of display for the notifications. For example, if the notification includes a photograph and there is a tag associated with the photograph, that identifies a particular person, then the order module 204 may update the priority of this notification based on the priority associated with notifications coming from this person.

Further, in an embodiment of the present invention, the order module 204 may determine attention time (for example, urgency) and attention level related to notifications based upon source of the notification, subject of the notification, and the content of the notification. If a particular notification requires urgent attention of the user, then the order module 204 may display that notification at top of the notification list. Further, if a particular notification does not have any time line associated, or does not require urgent attention of the user, then the order module 204 may display that notification at bottom of the notification list.

Further, in an embodiment of the present invention, the order module 204 may identify voice in the notification (for example, in voice call) based on the voice attributes stored in the internal database 130. Based on the identified voice, the order module 204 may automatically update the priority of the notification. For example, even if a person A calls from a pay phone, and if the order module finds a voice attribute for the voice of the person, it may determine that this is person A's voice, and hence, the order module 204 may change the priority of the notification.

Hence, the order module 204 utilizes the user's interactions with previous notifications and applications, and uses the user's interactions as input in decision of prioritizing future notifications. This allows future notifications (regardless of the sender/caller and application which generated it) to be prioritized. For example, if the user always returns missed calls to family members, the order module 204 always sorts missed calls notifications from the family members above the other missed call notifications.

Further, if these names (family names) appear in notifications from text or email applications, the order module 204 prioritize those as well. Further, if a user never clicks on a particular notification and always deletes it, the order module 204 remembers the text keywords in those notifications and will sort future notifications (both from that application and potentially from other applications) to the bottom of the list. In an embodiment of the present invention, the order module 204, over time, may prevent those notifications from initially being displayed.

In an embodiment of the present invention, the order module 204 is further configured to divide notifications among high priority notifications, medium priority notifications, and low priority notifications based upon a predefined threshold. The predefined threshold may have some default threshold value (for example, 500) or some value assigned by the user. The order module 204 may associate a score with each notification (for example, 500). Further, the order module 204 may update a score associated with each notification based upon the user's interactions with previous notifications and applications. For example, if the user always responds to notifications coming from a particular source, e.g., his wife, family member, boss, colleague, etc., the order module 204 may automatically update (i.e., increase) the score associated with notifications coming from those sources/persons.

If the user always ignores notifications coming from another source, for example, a neighbour, an ex-girlfriend, etc., the order module 204 may decrease the score associated with the notifications coming from those sources/persons. Further, if the user keeps ignoring phone missed call notifications but always responds back to SMS notifications, the order module 204 may increase the score associated with the SMS notifications, and decrease the score associated with the phone missed call notifications.

Hence, the order module 204 dynamically updates scores associated with each notification based upon the user's previous interactions, and dynamically changes order of the notification in the list according to the score. In one embodiment of the present invention, the order module 204 lists a notification in the list, only if the score associated with the notification is above the threshold value (for example, above 500). In another embodiment of the present invention, the order module 204 may change the order of the notification in the list based upon the score associated with the notification.

Further, the order module 204 is also configured to prioritize among very frequently-used applications. For example, if there are two applications which both have approximately same usage frequency, and notifications for both applications exist at the same time, then the order module 204 is configured to decide which application appears to get invoked first. For example, person A and person B are equally important to the user and the user always responds to their communications. Person A only calls and leaves messages and person B always sends SMS text messages. The order module 204 can determine which application (phone or text) appears to get invoked first when the user has phone AND text notifications at the same time, and use that to give one application priority over the other. If the user always answers texts AND calls, but always seems to answer texts first, then the order module 204 assigns text notifications slightly higher priority than call notifications.

Further, in an embodiment of the present invention, the order module 204 is configured to find a notification which may trump all other notifications in terms of importance. The internal database 130 may store some keywords related to trump notifications. The order module 204 is configured to check those keywords in each notification and list the notification at top of the list. The order module 204 may trigger all alerts for such kind of notification, and do not stop the alerts till the user has read the notification. For example, the internal database 130 may store ‘911’, ‘emergency, ‘security’ keywords related to trump notification. The order module is configured to list such notification at top of the notification list.

The display module 206 displays the notifications on the display 122 based on the determined order. In an embodiment of the present invention, the display module 206 is configured to display the notifications on the display 122 of the user device 102 based on the order determined by the order module 204. Further, in an embodiment of the present invention, the display module 206 may group the notifications according to application, message type etc. and display the prioritized list of notifications for those groups. In another embodiment of the present invention, the display module 206 is configured to display the notifications based on user preferences and setting as described below.

Further, in an embodiment of the present invention, the display module 206 is further configured to generate an alert based upon a priority of the notification. The display module 206 is configured to generate a plurality of alerts comprising beeps, vibrate, and popup for a high priority notification (for example, notification which has a priority value over 800). Those skilled in the art will appreciate that the plurality of alerts with the high priority notification will help the user in avoiding missing any important notification. The display module 206 is configured to generate two alerts for the medium priority notification (for example, notification which has a priority value between 500 and 800). The display module 206 is configured to generate a single alert for a low priority notification (for example, notification which has a priority value less than 500).

The customization module 208 is configured to allow a user to customize the order of display for notifications. In an embodiment of the present invention, the customization module 208 is configured to allow a user to customize the order of display for notifications based upon a source (i.e., caller/sender) associated with a notification. In another embodiment of the present invention, the customization module 208 is further configured to allow a user to customize the order of display for notifications based upon an application associated with the notification.

In yet another embodiment of the present invention, the customization module 208 is configured to allow a user to customize the order of display for notifications based upon content (keywords in text, images, video etc.) associated with the notification. In yet another embodiment of the present invention, the customization module 208 is configured to allow a user to customize the order of display for notifications based upon urgency in attention (for example, urgent attention) required by the notifications. The customization module 208 is further configured to allow a user to set a threshold for dividing notifications among high priority notifications, medium priority notifications, and low priority notifications. The order module 206 may utilize this threshold in determining priority of the notifications.

For example, the customization module 208 allows a user to specify that the notification list provided by the user device never drop any phone call notifications or any missed call notifications from a specific person. Further, the customization module 208 allows the user to specify that the SMS notifications must always be shown before the phone call notifications.

Further, in an embodiment of the present invention, the customization module 208 allows the user to modify the setting in future, according to user preferences. Those skilled in the art will appreciate that priority of the user may change in future. For example, something or someone that is very important today, it may not be that important in future. Hence, the user may modify earlier setting to match his current requirement. Further, the customization module 208 allows the user to help learn the dynamic notification system about the user preferences. For example, the user may be asked to answer some questions.

In an embodiment of the present invention, the dynamic notification system may also display the learning about the user's choices about various notifications, and the user may approve or reject the leanings of the dynamic notification system. The user may also overrule the learning of the dynamic notification system. In another embodiment of the present invention, the dynamic notification system may work independently without requiring any user input. Further, all setting provided by the user may be stored in the internal database 130.

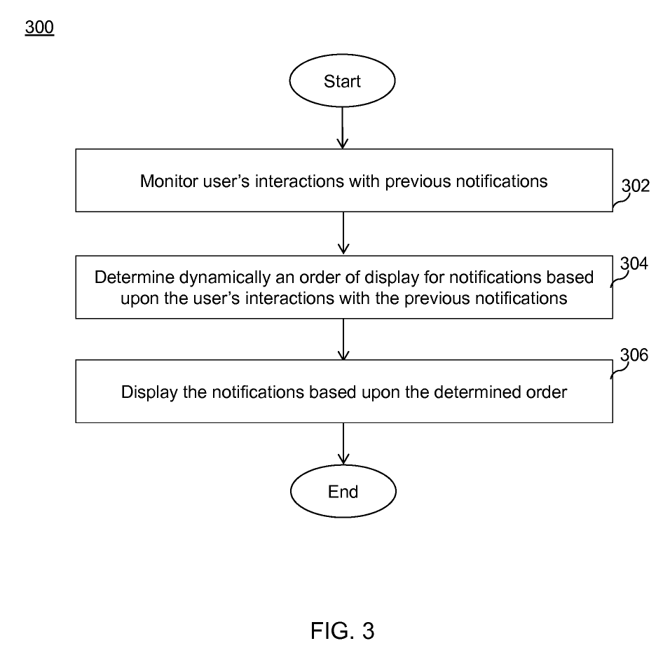

FIG. 3 illustrates a method 300 for managing notifications on a user device.

At step 302, user's interactions with previous notifications are monitored. In an embodiment of the present invention, the user may interact or respond to notifications based upon a source associated with the notification. For example, the user may always respond to a particular notifications coming from a particular source, for example, his wife, family member, boss, colleague, etc. Further, the user may always ignore notifications coming from another source, for example, a neighbour, an ex-girlfriend, etc. Further, in another embodiment of the present invention, the user may interact or respond to notifications based upon an application associated with the notifications. For example, the user may keep ignoring phone missed call notifications but always responds back to SMS notifications. Further, in yet another embodiment of the present invention, the user may interact or respond to notifications based upon content (for example, text, images, multi-media content etc.) of the notifications. For example, the user may always read completely an email or message for new business opportunity. However, the user may not read a spam email or message. Hence, texts from previous notifications acted upon by the user may be remembered. Further, the user may always like going through certain type of images and multi-media content. Further, the user's interaction with the notification may be stored in the internal database 130. In an embodiment of the present invention, the user's interactions with previous notifications may be monitored by the monitor module 202.

At step 304, an order of display for notifications is dynamically determined based upon the user's interactions with the previous notifications. The order of display for the notification may include more important notifications for the user at top of notification list, and less important notification for the user at bottom of the notification list. For example, if the user always responds to notifications coming from a particular source, e.g., his wife, family member, boss, colleague, etc., notifications coming from those sources may be sorted at top of the list of notifications. Further, if the user always ignores notifications coming from another source, for example, a neighbour, an ex-girlfriend, etc., notifications from those sources may be sorted at bottom of the list of notifications.

Similarly, if the user keeps ignoring phone missed call notifications but always responds back to SMS notifications, then SMS notifications may be sorted at top of the list of notifications and the missed call notifications may be sorted at bottom of the list of notifications. In an embodiment of the present invention, the order of display for notifications may be determined by the order module 204.

At step 306, the notifications are displayed based upon the determined order. In an embodiment of the present invention, the notifications may be displayed based on the dynamically determined order. Further, in an embodiment of the present invention, the notifications may be grouped according to application; message type, etc. and the prioritized list of notifications may be displayed for those groups. In another embodiment of the present invention, the notifications may be displayed based on user preferences and setting.

Further, in an embodiment of the present invention, an alert may be generated based upon a priority of the notification. For example, a plurality of alerts comprising beeps, vibrate, and popup may be generated for a high priority notification. Further, two alerts for the medium priority notification may be generated and a single alert for a low priority notification may be generated. In an embodiment of the present invention, the notifications may be displayed by the display module 206.

Further, (in an optional step), the order of display of notification may be shared with advertisers. Hence, the advertisers may send the advertisements with a particular notification or notifications that is/are going to display at top of the notification list of the user. Since, the user is more likely to view a notification at top of the notification list, and hence the user is more likely to view the advertisement displayed in the notification lying at top of the notification list. Hence, the advertisers may get a better return on investment.

The exemplary systems and methods of this present invention have been described in relation to a user device (e.g., smart device). However, to avoid unnecessarily obscuring the present invention, the preceding description omits a number of known structures and devices. This omission is not to be construed as a limitation of the scope of the claimed invention. Specific details are set forth to provide an understanding of the present invention. It should however be appreciated that the present invention may be practiced in a variety of ways beyond the specific detail set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the present invention.

A number of variations and modifications of the present invention can be used. It would be possible to provide for some features of the present invention without providing others.

For example in one alternative embodiment of the present invention, the systems and methods of this present invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software, firmware or hardware is used to implement the systems in accordance with this present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, the present invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the present invention has been presented for purposes of illustration and description. The foregoing is not intended to limit the present invention to the form or forms disclosed herein. In the foregoing Detailed Description, for example, various features of the present invention are grouped together in one or more embodiments, configurations, or aspects for the purpose of streamlining the disclosure.

The features of the embodiments, configurations, or aspects of the present invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A dynamic notification system for managing notifications on a user device, comprising:
a monitor module configured to monitor user's interactions with previous notifications on the user device;
an order module configured to dynamically determine an order of display for notifications based on the user's interactions with the previous notifications; and
a display module configured to display the notifications based on the determined order.

2. The dynamic notification system of claim 1, wherein the monitor module is further configured to remember text from previous notifications acted upon by a user.

3. The dynamic notification system of claim 2, wherein the order module is configured to utilize the text from the previous notifications acted upon by the user for determining order of display for the notifications.

4. The dynamic notification system of claim 1, wherein the monitor module is further configured to monitor user's interactions with applications associated with the previous notifications.

5. The dynamic notification system of claim 4, wherein the order module is further configured to prioritize notifications associated with an application based upon the user's interaction with the previous notifications associated with the application.

6. The dynamic notification system of claim 1, wherein the order module is configured to divide notifications among high priority notifications, medium priority notifications, and low priority notifications based upon a predefined threshold.

7. The dynamic notification system of claim 6, wherein the display module is configured to generate an alert based upon a priority of the notification.

8. The dynamic notification system of claim 7, wherein the display module is configured to generate a plurality of alerts comprising beeps, vibrate, and popup for a high priority notification.

9. The dynamic notification system of claim 7, wherein the display module is configured to generate a single alert for a low priority notification.

10. The dynamic notification system of claim 1, further comprising a customization module configured to allow a user to customize the order of display for notifications based upon a source associated with a notification.

11. The dynamic notification system of claim 10, wherein the customization module is further configured to allow a user to customize the order of display for notifications based upon an application associated with the notification.

12. The dynamic notification system of claim 11, wherein the display module is configured to display SMS notifications before phone call notifications.

13. The dynamic notification system of claim 1, further comprising an internal database configured to store the user's interactions with the previous notifications and the applications.

14. A computer-implemented method for managing notifications on a user device, the method comprising:
monitoring user's interactions with previous notifications on a user device;
determining dynamically an order of display for notifications based on the user's interactions with the previous notifications; and
displaying the notifications based on the determined order.

15. The computer-implemented method of claim 14, further comprising monitoring user's interactions with applications associated with the notifications.

16. The computer-implemented method of claim 15, further comprising prioritizing notifications associated with an application based on the user's interaction with the previous notifications associated with the application.

17. The computer-implemented method of claim 14, further comprising generating a plurality of alerts comprising beeps, vibrate, and popup for a high priority notification.

18. The computer-implemented method of claim 14, further comprising generating a single type of alert for a low priority notification.

19. The computer-implemented method of claim 14, further comprising allowing a user to customize the order of display for notifications based upon a source or application associated with a notification.

20. A computer readable medium storing computer readable instructions when executed by a processor perform a method comprising:
monitoring user's interactions with previous notifications on a user device;
determining dynamically an order of display for notifications based on the user's interactions with the previous notifications; and
displaying the notifications based on the determined order.
